(19) United States
(12) Patent Application Publication
(10) Pub. No.: US 2024/0155418 A1
(43) Pub. Date: May 9, 2024

(54) METHOD AND APPARATUS FOR CONNECTING QOS FLOW BASED TERMINAL IN WIRELESS COMMUNICATION SYSTEM

(71) Applicant: Samsung Electronics Co., Ltd., Gyeonggi-do (KR)

(72) Inventors: Jicheol LEE, Gyeonggi-do (KR); Hyesung KIM, Gyeonggi-do (KR); Jaehyeon BAE, Gyeonggi-do (KR)

(21) Appl. No.: 18/500,587

(22) Filed: Nov. 2, 2023

(30) Foreign Application Priority Data
Nov. 3, 2022 (KR) 10-2022-0145247

(51) Int. Cl. H04W 28/02; H04W 48/16

(52) U.S. Cl. CPC H04W 28/0268; H04W 48/16

(57) ABSTRACT

The disclosure relates to a 5G or 6G communication system for supporting a higher data transmission rate. A method performed by a UE in a wireless communication system includes receiving, from at least one electronic device, a first message requesting a connection to a PIN, identifying to generate a QoS flow for the at least one electronic device, based on the first message, transmitting, to an SMF entity, via an AMF entity, a second message requesting a PDU session modification corresponding to the PIN, receiving, from a BS, a PDU session modification command message including a QoS rule, and applying the QoS rule to the at least one electronic device.

### CROSS-REFERENCE TO RELATED APPLICATION(S)

This application is based on and claims priority under 35 U.S.C. § 119(a) to Korean Patent Application No. 10-2022-0145247, which was filed in the Korean Intellectual Property Office on Nov. 3, 2022, the entire disclosure of which is incorporated herein by reference.

### BACKGROUND

### 1. Field

The disclosure relates generally to a wireless communication system and, more specifically, to a method and an apparatus for connecting a user terminal to a quality of service (QoS) flow-based personal Internet of things (IoT) network (PIN) in a wireless communication system.

### 2. Description of Related Art

5^{th} generation (5G) mobile communication technologies define broad frequency bands such that high transmission rates and new services are possible, and can be implemented in “sub 6 GHz” bands such as 3.5 GHz, and also in “above 6 GHz” bands, which may be referred to as mmWave, including 28 GHz and 39 GHz. In addition, it has been considered to implement 6^{th} generation (6G) mobile communication technologies (or beyond 5G systems) in terahertz (THz) bands (e.g., 95 GHz to 3THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input, multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for a large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by future 5G mobile communication technologies, such as physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, a non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial IoT (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of these connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to address a problem generated while configuring a PIN by a user device connected to a 5G network in a wireless communication system, and connecting and using a PIN device through a PIN gateway.

More specifically, when a PIN device, such as an XR device, requiring low latency is connected by a PIN connection, provision of a maximum flow bit rate (MFBR) or a guaranteed flow bit rate (GFBR) for each PIN device (e.g., XR device) is impossible. A conventional QoS rule provides a QoS flow mapping function through a filter for distinguishing traffic. However, if a PIN gateway uses a network address translation (NAT) function, it is impossible to provide a function of mapping to a QoS flow for each PIN device by only using a traffic descriptor of a modem without help of the PIN gateway.

In addition, a terminal having a PIN gateway function is to provide, to an XR device, a low latency, low loss, and scalable (L4S) function for transferring the traffic of the XR device at low latency while linking the function to a QoS flow provided in a 5G network.

In accordance with an aspect of the disclosure, a method is provided for a UE in a wireless communication system. The method includes receiving, from at least one electronic device, a first message requesting a connection to a PIN, identifying to generate a QoS flow for the at least one electronic device, based on the first message, transmitting, to a session management function (SMF) entity via an access and mobility management function (AMF) entity, a second message requesting a protocol data unit (PDU) session modification corresponding to the PIN, receiving, from a base station (BS), a PDU session modification command message including a QoS rule, and applying the QoS rule to the at least one electronic device.

In accordance with another aspect of the disclosure, a UE is provided for use in a wireless communication system. The UE includes a transceiver, and a controller coupled with the transceiver and configured to receive, from at least one electronic device, a first message requesting a connection to a PIN, identify to generate a QoS flow for the at least one electronic device, based on the first message, transmit, to an SMF entity, via an AMF entity, a second message requesting a PDU session modification corresponding to the PIN, receive, from a BS, a PDU session modification command message including a QoS rule, and apply the QoS rule to the at least one electronic device for the PIN.

In accordance with another aspect of the disclosure, a method is provided for an SMF entity in a wireless communication system. The method includes receiving, from a UE, via an AMF entity, a session management (SM) context update request message including a message requesting a PDU session modification corresponding to a PIN, transmitting, to a policy control function (PCF) entity, an SM policy control request message, based on the SM context update request message, receiving, from the PCF entity, an SM policy control response message including information related to a QoS policy for at least one electronic device in response to the SM policy control request message, and transmitting, to a user plane function (UPF) entity, an N4 update message requesting update of traffic policy for an N4 interface for the PIN.

In accordance with another aspect of the disclosure, an SMF entity is provided for use in a wireless communication system. The SMF entity includes a transceiver, and a controller coupled with the transceiver and configured to receive, from a UE, via an AMF entity, an SM context update request message including a message requesting a PDU session modification corresponding to a PIN, transmit, to a PCF entity, an SM policy control request message, based on the SM context update request message, receive, from the PCF entity, an SM policy control response message including information related to a QoS policy for at least one electronic device in response to the SM policy control request message, and transmit, to a UPF entity, a N4 update message requesting update of traffic policy for an N4 interface for the PIN.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network structure and interfaces of a 5G system according to an embodiment;

FIG. 2 illustrates a network structure and interfaces of a 5G system according to an embodiment;

FIG. 3 illustrates a PIN QoS structure connecting a PIN device based on a QoS flow in a wireless communication system according to an embodiment;

FIG. 4A is a signal flow diagram illustrating a method of generating a session for connection of a PIN device according to an embodiment;

FIG. 4B is a signal flow diagram illustrating a method of generating a session for connection of a PIN device according to an embodiment;

FIG. 4C is a signal flow diagram illustrating a method of generating a session for connection of a PIN device according to an embodiment;

FIG. 5 illustrates a terminal mapping a QoS flow to each PIN device according to an embodiment;

FIG. 6 is a signal flow diagram illustrating a method of generating a PIN QoS-supportable PDU session according to an embodiment;

FIG. 7 is a flowchart illustrating a method of an SMF entity in a wireless communication system according to an embodiment;

FIG. 8 is a flowchart illustrating a method of a terminal in a wireless communication system according to an embodiment;

FIG. 9 illustrates a BS according to an embodiment; and

FIG. 10 illustrates a terminal according to an embodiment.

### DETAILED DESCRIPTION

Hereinafter, various embodiments of the disclosure will be described in detail in conjunction with the accompanying drawings. In describing the disclosure, detailed descriptions of known functions or configurations incorporated herein will be omitted when it is determined that the descriptions may make the subject matter of the disclosure unnecessarily unclear.

The terms which will be described below are terms defined in consideration of the functions in the disclosure, and may be different according to users, intentions of the users, or customs. Therefore, the definitions of the terms should be made based on the contents throughout the specification.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Throughout the specification, the same or like reference numerals designate the same or like elements.

In the following description, a BS is an entity that allocates resources to terminals, and may be at least one of a gNode B, an eNode B, a Node B, a wireless access unit, a BS controller, and a node on a network. A terminal may include a UE, a mobile station (MS), a cellular phone, a smartphone, a computer, or a multimedia system capable of performing communication functions. Herein, a “downlink (DL)” refers to a radio link from a BS to a terminal, and an “uplink (UL)” refers to a radio link from a terminal to a BS.

In the following description, long term evolution (LTE) or LTE advanced (LTE-A) systems may be described by way of example, but the embodiments of the disclosure may also be applied to other communication systems having similar technical backgrounds or channel types. Examples of such communication systems may include 5G mobile communication technologies (e.g., NR) developed beyond LTE-A, and in the following description, the “5G” may be the concept that covers the existing LTE, LTE-A, or other similar services.

In addition, based on determinations by those skilled in the art, the embodiments of the disclosure may also be applied to other communication systems through some modifications without significantly departing from the scope of the disclosure.

Herein, each block of the flowchart illustrations, and combinations of blocks in the flowchart illustrations, may be implemented by computer program instructions.

These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). In some implementations, the functions noted in the blocks may occur in a different order. For example, two blocks shown in succession may in fact be executed substantially concurrently or the blocks may sometimes be executed in the reverse order, depending upon the functionality involved.

As used herein, a “unit” refers to a software element or a hardware element, such as a field programmable gate array (FPGA) or an application specific integrated circuit (ASIC), which performs a predetermined function. However, a “unit” does not always have a meaning limited to software or hardware. A “unit” may be constructed either to be stored in an addressable storage medium or to execute one or more processors. Therefore, a “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, a “unit” may include one or more processors.

The 3^{rd} generation partnership project (3GPP), which manages a cellular mobile communication standard, has introduced a new core network structure named 5G core (5GC) and has been standardizing the same in order to push evolution from a 4th generation (4G) LTE system to a 5G system. 5GC supports a number of distinguishable functions, compared to an evolved packet core (EPC), which is a network core for 4G.

According to requirements of 5G, 5GC is required to support various terminal types and services, e.g., eMBB, URLLC, and mMTC. Such terminals/services have different requirements for a core network. For example, the eMBB service may require a high data rate, and the URLLC service may require high stability and low latency. In 5GC network slicing technology has been proposed to satisfy these various service requirements.

Network slicing may include a method of virtualizing a physical network to make many logical networks (e.g., network slices). Activated network slices may be called network slice instances (NSIs), and each NSI may have a different characteristic.

A mobile communication service provider may configure a network function (NF) suitable for the characteristic of each NSI so as to satisfy various service requirements according to terminals/services. For example, the mobile communication service provider may assign an NSI suitable for the characteristic of a required service, so that many 5G services (e.g., eMBB, URLLC, and/or mMTC) are efficiently supportable.

5GC may support a network virtualization paradigm by separating a mobility management function and an SMF.

In 4G LTE, all terminals have been provided with services from a network through signaling exchange with a single core equipment, which is called a mobility management entity (MME) serving as registration, authentication, and a mobility management and SMF.

In 5G, the number of terminals (e.g., MTC terminals) has grown, and mobility and traffic/session characteristics to be supported are subdivided according to the types of terminals. Accordingly, if a single entity (e.g., an MME) supports all functions, decrease in scalability indicating the addition of an entity for each required function is inevitable. Therefore, in order to improve scalability in terms of signaling loads and the function/implementation complexity of a core entity responsible for a control plane, various functions are being developed based on a structure of separating a mobility management function and an SMF.

According to an embodiment of the disclosure, a service provider may provide a QoS function for each PIN device with respect to devices connected through a PIN to a subscriber terminal having a PIN gateway function. The provided QoS function, like L4S, may provide a function of assigning a low latency queue and marking an explicit congestion notification (ECN) bit of an internet protocol (IP) header when congestion occurs.

Abbreviations related to a PIN and used in the disclosure are described below. However, the disclosure is not limited to the following description.
PIN: A network in which PIN element devices are connected to each other by a PIN technology through a non-3GPP wired/wireless technology and are able to exchange data to each other. For example, Wi-Fi, Bluetooth Low Energy (BLE), Ethernet, and Universal Serial Bus (USB) may correspond to the network.
PIN element (PINE): This indicates a device connected in a PIN.
PIN element with gateway capability (PEGC): This indicates a gateway function among devices connected in a PIN.
PIN element with management capability (PEMC): This indicates a function of managing devices connected in a PIN.
Non-3GPP PIN communication type (N3PT): This indicates a technology type of connecting devices of a PIN through various non-3GPP-based wired/wireless technologies and, e.g., corresponds to a communication technology such as Wi-Fi, BLE, Ethernet, or USB.
PINE to QoS flow mapping function: When a device identified as a PINE is connected to a PIN, the PINE and a QoS flow are mapped, and traffic received from the PINE is transferred to a 5GC through the QoS flow.
L4S processing function: This separately manages a packet received from a PIN device of a PIN and detects congestion occurrence. When congestion occurrence is detected, L4S marking may be performed for corresponding traffic.

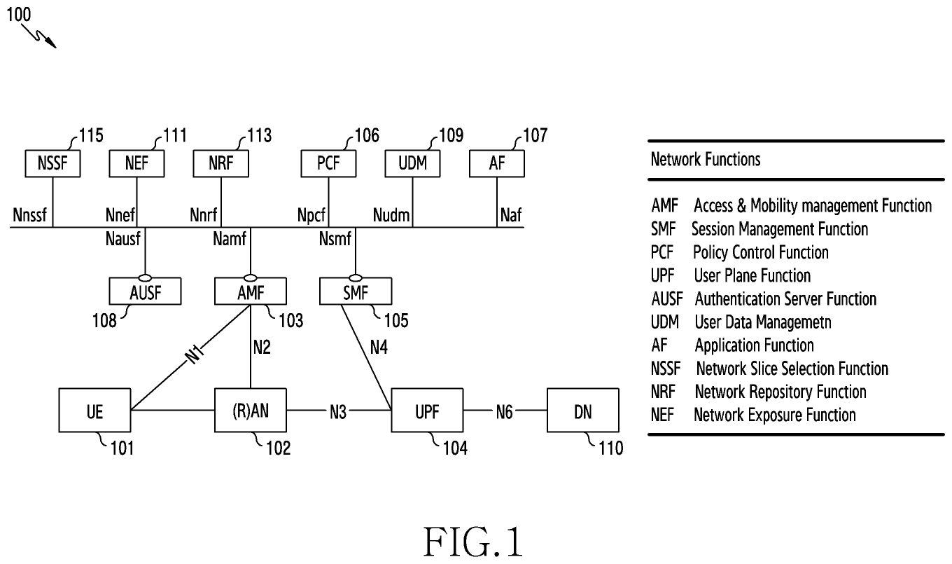

FIG. 1 illustrates a network structure and interfaces of a 5G system according to an embodiment. For example, a network entity included in the network structure of the 5G system of FIG. 1 may include an NF according to system implementation.

Referring to FIG. 1, the network structure of the 5G system include various network entities. For example, the 5G system includes an authentication server function (AUSF) 108, a (core) AMF 103, an SMF 105, a PCF 106, an application function (AF) 107, a unified data management (UDM) 109, a data network (DN) 110, a network exposure function (NEF) 111, an edge application service domain repository (EDR) (not illustrated), an edge application server (EAS)(not illustrated), an EAS discovery function (EASDF) (not illustrated), a user plane function (UPF) 104, a radio access network ((R)AN) 102, a UE 101, a network slicing selection function (NSSF) 115, and an NF repository function (NRF) 113.

Each NF of the 5G system 100 may support the following functions. However, the disclosure is not limited thereto.

The AUSF 108 may process and store data for authentication of the UE 101.

The AMF 103 may provide a function for access and mobility management in a unit of UE, and one UE may be basically connected to one AMF. More specifically, the AMF 103 may support functions such as inter-core network (CN) node signaling for mobility between 3GPP access networks, termination of a RAN control plane (CP) interface (i.e., an N2 interface), a termination (N1) of non-access stratum (NAS) signaling, NAS signaling security (e.g., NAS ciphering and integrity protection), access stratum (AS) security control, registration management (e.g., registration area management), connection management, idle mode UE reachability (including control and execution of paging retransmission), mobility management control (e.g., subscription and policies), support of intra-system mobility and inter-system mobility, support of network slicing, SMF selection, lawful interception (e.g., for an AMF event and an interface for an LI system), provision of transport of SM messages between the UE and the SMF, a transparent proxy for routing SM messages, access authentication, access authorization including a roaming right check, provision of transport of SMS messages between the UE and the SMSF, a security anchor function (SAF), and/or a security context management (SCM). Some or all functions of the AMF 103 may be supported in a single instance of one AMF.

The DN 110 may include an operator service, an Internet access or 3rd party service, etc. The DN 110 may transmit a DL PDU to the UPF 104, or receive a PDU transmitted from the UE 101 from the UPF 104.

The PCF 106 may receive information on a packet flow from an application server, to provide a function of determining a policy such as mobility management, SM, etc. Specifically, the PCF 106 may support a function, such as support of a unified policy framework for controlling network operation, provision of a policy rule to enable control plane function(s) (e.g., the AMF 103 or the SMF 105) to execute the policy rule, and implementation of a front end (FE) for accessing relevant subscription information for policy determination in a user data repository (UDR).

The SMF 105 may provide an SMF, and when the UE has multiple sessions, the sessions may be managed by different SMFs. Specifically, the SMF 105 supports a function, such as SM (e.g., this may mean an operation of session establishment, modification, and release, including tunnel maintenance between the nodes of the UPF 140 and the (R)AN 102), UE IP address allocation and management (including selective authentication), selection and control of a UP function, configuration of traffic steering at the UPF 104 to route traffic to a proper destination, termination of interfaces towards PCFs, execution of a control part of a policy and a QoS, lawful interception (e.g., this may relate to an SM event and an interface to an LI system), termination of SM parts of NAS messages, DL data notification, an initiator of AN-specific SM information (this is transferred to the (R)AN 102 through N2 via the AMF 103), determination of a session and service continuity (SSC) mode of a session, and a roaming function. Some or all functions of the SMF 105 may be supported in a single instance of one SMF.

The UDM 109 may store user subscription data, policy data, etc. The UDM 109 may include two parts, i.e., an application FE and a UDR.

The FE may include a UDM FE in charge of location management, subscription management, and credential processing, and the PCF 106 in charge of policy control. The UDR may store data required for functions provided by the UDM-FE, and a policy profile required by the PCF 106. The data stored in the UDR may include a subscription identifier, a security credential, user subscription data including access and mobility-related subscription data and session-related subscription data, and policy data. The UDM-FE may access subscription information stored in the UDR, and may support a function such as authentication credential processing, user identification handling, access authentication, registration/mobility management, subscription management, and SMS management.

The UPF 104 may transfer a DL PDU received from the DN 110 to the UE 101 via the (R)AN 102, and may transfer, to the DN 110, a UL PDU received from the UE 101 via the (R)AN 102. Specifically, the UPF 104 may support a function, such as an anchor point for intra/inter-radio access technology (RAT) mobility, an external PDU session point of interconnection to a DN, packet routing and forwarding, packet inspection and a user plane part of policy rule enforcement, lawful interception, traffic usage reporting, a UL classifier for supporting to route traffic flows to a DN, a branching point for supporting a multi-homed PDU session, QoS handling for a user plane (e.g., packet filtering, gating, and UL/DL rate enforcement), UL traffic verification (e.g., a service data flow (SDF) mapping between an SDF and a QoS flow), transport level packet marking in UL and DL, and a DL packet buffering and DL data notification triggering function. Some or all functions of the UPF 104 may be supported in a single instance of one UPF 104.

The AF 107 may interact with a 3GPP core network for service provision (e.g., this may imply supporting of a function, such as application influence on traffic routing, access to network capability exposure, and interaction with a policy framework for policy control).

The (R)AN 102 is a generic term for a new RAN supporting both an evolved E-UTRA that is an evolved version of a 4G radio access technology, and a new radio access technology (NR) (e.g., a gNB).

The gNB may support a function, such as functions for radio resource management (i.e., radio bearer control, radio admission control, connection mobility control, and dynamic allocation of resources to the UE in UL/DL (i.e., scheduling)), IP header compression, encryption and integrity protection of a user data stream, selection of the AMF at UE attachment when no routing towards the AMF is determined through information provided by the UE, routing of user plane data to the UPF(s), routing of control plane information to the AMF, connection setup and release, scheduling and transmission of paging messages (e.g., initiated from the AMF), scheduling and transmission of system broadcast information (this may indicate system broadcast information initiated from the AMF or operating and maintenance (O&M)), measurement and measurement reporting configuration for mobility and scheduling, transport level packet marking in UL, SM, support of network slicing, QoS flow management and mapping to a data radio bearer, support of the UE in an inactive mode, a NAS message distribution function, a NAS node selection function, sharing of a radio access network, dual connectivity, and tight interworking between NR and E-UTRA.

The UE 101 may indicate a user device. For example, the UE 101 may be a terminal, mobile equipment (ME), and an MS. In addition, the UE 101 may be a portable device, such as a notebook, a mobile phone, a personal digital assistant (PDA), a smartphone, or a multimedia device, or an unportable device such as a personal computer (PC) or a vehicle-mounted device.

The NEF 111 may provide a functionality for securely exposing services and capabilities provided by 3GPP NFs, e.g., for a 3rd party, internal exposure/re-exposure, AFs, and edge computing. The NEF 111 may receive information (based on exposed capability(s) of other NF(s)) from the other NF(s). The NEF 111 may store received information as structured data by using a standardized interface as a data storage NF. The stored information may be re-exposed to other NF(s) and AF(s) by the NEF 111, and may be used for other purposes such as analysis.

The EASDF is an NF that is capable of adding, for each fully qualified domain name (FQDN), an address of a domain name system (DNS) server to which a DNS request of the terminal is to be forwarded, and an extension mechanisms for DNS (EDNS) client subnet (ECS) option representable by an IP subnet address required to be added when the DNS request of the terminal is forwarded. The EASDF may receive EAS domain configuration information from the EDR, and process a DNS request message received from the terminal, according to the received information. In addition, the EASDF may be an NF that performs a function of receiving, from the SW′ 105, a terminal IP address, location information of the terminal in 3GPP, a DNS message handling rule, and a DNS message reporting rule, handling a DNS query message received from the terminal and a DNS response message received from a DNS server, and transmitting, according to the DNS message reporting rule, information in a DNS message and statistical information obtained by processing same to the SMF 105.

The NRF 113 may support a service discovery function. The NRF 113 may receive an NF discovery request from an NF instance, and provide information of discovered NF instances to the NF instance. In addition, the NRF 113 may maintain available NF instances and services supported thereby. All NFs illustrated in FIG. 1 may interact with the NRF 113 if needed.

The NSSF 115 may select a set of network slice instances serving the UE 101. In addition, the NSSF 115 may determine allowed network slice selection assistance information (NSSAI) and, if necessary, may map same to pieces of subscribed single-NSSAI (S-NSSAIs). In addition, the NSSF 115 may determine configured NSSAI and, if necessary, map same to subscribed S-NSSAIs. In addition, the NSSF 115 may determine an AMF set used to serve the UE, or query the NRF 113 according to a configuration to determine a list of candidate AMFs.

A reference model for when the UE 101 accesses the one DN 110 by using one PDU session is illustrated in FIG. 1 as an example for convenience of explanation, but the disclosure is not limited thereto. For example, the UE 101 may concurrently access two (i.e., local and central) DNs by using multiple PDU sessions. Two SMFs 105 may be selected for different PDU sessions. Each SMF 105 may be capable of controlling both a local UPF 104 and a central UPF 104 in a PDU session.

In addition, the UE 101 may concurrently access two (i.e., local and central) DNs provided in a single PDU session.

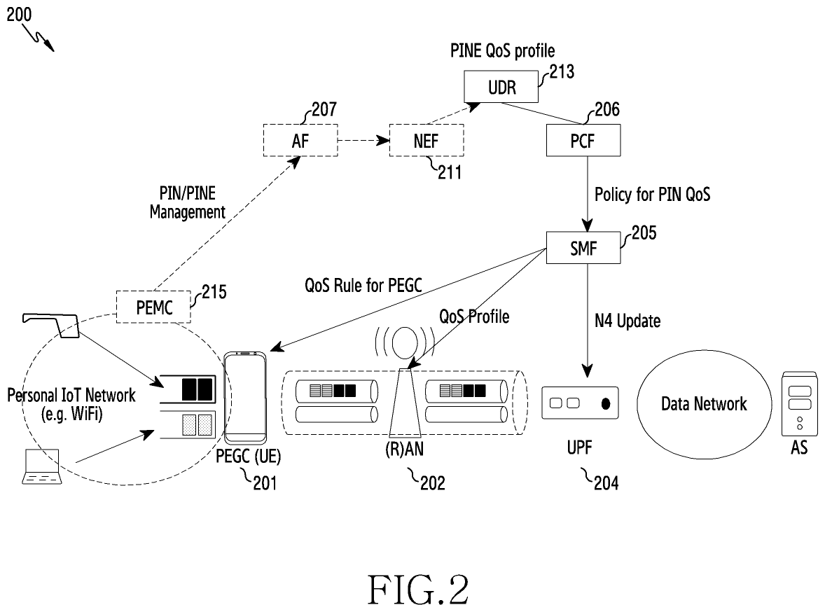

In a 3GPP system, a conceptual link connecting NFs in a 5G system may be defined as a reference point. For example, reference point(s) included in the 5G system of FIG. 1 include, but are not limited to:
N1: A reference point between the UE 101 and the AMF 103
N2: A reference point between the (R)AN 102 and the AMF 103
N3: A reference point between the (R)AN 102 and the UPF 104
N4: A reference point between the SMF 105 and the UPF 104
N5: A reference point between the PCF 106 and the AF 107
N6: A reference point between the UPF 104 and the DN 110
N7: A reference point between the SMF 105 and the PCF 106
N8: A reference point between the UDM 109 and the AMF 103
N9: A reference point between two core UPFs 104
N10: A reference point between the UDM 109 and the SMF 105
N11: A reference point between the AMF 103 and the SMF 105
N12: A reference point between the AMF 103 and the AUSF 108
N13: A reference point between the UDM 109 and the AUSF 108
N14: A reference point between two AMFs 103
N15: In a non-roaming scenario, a reference point between the PCF and the AMF, and in a roaming scenario, a reference point between the AMF and the PCF in a visited network
Nx: A reference point between the SMF 105 and an EASDF
Ny: A reference point between the NEF (EDF) 111 and an EASDF FIG. 2 illustrates a network structure and interfaces of a 5G system according to an embodiment.

Referring to FIG. 2, a 5G system 200 includes a UE 201, a (R)AN 202, a UPF 204, an SMF 205, a PCF 206, an AF 207, and an NEF 211. Although not illustrated, the 5G system may also include an AMF, an AUSF, a UDM, a DN, an EASDF, an EDR, an NSSF, and an NRF.

The NSSF may select a set of network slice instances serving the UE 201. In addition, the NSSF may determine allowed NSSAI and, if necessary, may map same to pieces of subscribed S-NSSAIs. In addition, the NSSF may determine configured NSSAI and, if necessary, map same to subscribed S-NSSAIs. In addition, the NSSF may determine an AMF set used to serve the UE, or query the NRF according to a configuration to determine a list of candidate AMFs.

The NRF may support a service discovery function. The NRF receives an NF discovery request from an NF instance, and provides information of discovered NF instances to the NF instance. In addition, the NRF may maintain available NF instances and services supported thereby.

The terminal 201 (e.g., a UE with PEGC) has a gateway function (PIN gateway capability) of connecting a PIN to a 5G network. The PEGC may have a modem function of processing a wireless protocol of the 5G network. The UE with PEGC may have a module that processes a wireless technology for connecting a PIN through various non-3GPP PIN communication types, such as Wi-Fi, BLE, Ethernet, or USB. The PIN gateway capability (GC) function may provide a PIN gateway function enabling devices connected to the PIN to communicate with the 5G network through a terminal having a gateway function.

As described above, a PIN may be a sub-network connected to the rear end of the UE and configured by a non-3GPP connection technology. The PIN may be connected through a network such as Wi-Fi, BLE, or Ethernet, and connected through a network protocol such as IPv4 or IPv6.

Devices connected in a PIN are called PIN devices or PINEs. A PIN device, among PIN devices, being a 3GPP subscriber device (e.g., a UE) and having a PIN gateway function may be called a PEGC.

Referring to FIG. 2, an XR device and a notebook may correspond to PIN devices connected to the PIN, and may be connected to the PEGC 201 through the PIN. The PEGC 201 may perform a function of forwarding packets transmitted or received by PIN devices to or from the 5G network.

The PEGC 201 may implement a device for differentiated packet forwarding such as low latency queuing through a command of the SMF 205, and the device may provide an L4S function. For example, the PEGC 201 may buffer a packet received from the XR device and a packet received from the notebook to separate queues, and apply different QoS policies. The PEGC 201 may apply a different QoS rule to each PIN device according to QoS rules received from the SMF 205, and perform a function of distinguishing traffic of each PIN device and mapping same to a QoS flow provided from the 5GC. In addition, the PEGC 201 may perform an L4S marking function with respect to a PIN device connected to a QoS flow providing an L4S function. For example, when the PEGC 201 experiences congestion occurrence, the PEGC may mark, at the time of congestion occurrence, an ECN bit of an IP packet received from a PIN device with a congestion experience (CE) bit indicating a congestion state.

The PEMC 215 is an entity in the PIN, responsible for registering and managing a PIN device with respect to the PIN. The PEMC 215 may connect to the AF 207 and perform a procedure requiring management in the PIN. For example, when registration of a new PIN device in the PIN is required, the PEMC 215 may perform a procedure of registering the PIN device with respect to the AF 207. The AF 207 may perform a procedure related to a PIN policy in the 5GC via the NEF 211 when change and approval of a policy and a subscription condition in the 5GC are required in a process of registration in the PIN. For example, when approval of a policy relating to a QoS and registration of a new PIN device in the PIN is requested, the NEF 211 may store a relevant policy in the UDR 213 in a form of AF data, and transmit a DM notification to the PCF 206 to request application of the relevant policy. Alternatively, when a request of changing a policy relating to a PIN QoS is received from a NAF, the NEF 211 may transmit a QoS change request for the PIN or a PIN device to the PCF 206. The PCF 206 may receive such a request, determine a PIN or PIN device-related policy, and transfer the PIN or PIN device-related policy to the SMF 205 to allow the SMF 205 to perform a PDU session update procedure.

The PCF 206 may obtain a PIN or PIN device-related policy from the UDR 213. A PIN or PIN device-related policy stored in the UDR 213 may be a policy configured by a service provider in advance, or may be a policy stored from the AF 207 via the NEF 211.

The SMF 205 may receive a PIN or PIN device-related policy from the PCF 206, and update an N4 rule in the UPF 204 according to the related policy. In addition, the SMF 205 may generate a QoS profile to be transmitted to a BS and transmit same to the BS, and perform a function of generating and transferring a QoS rule for the PEGC to the terminal.

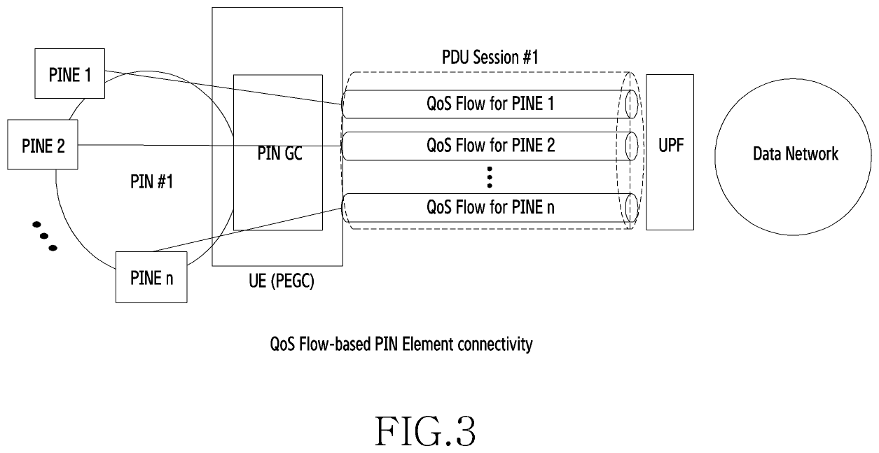

FIG. 3 illustrates a PIN QoS structure connecting a PIN device based on a QoS flow in a wireless communication system according to an embodiment.

Referring to FIG. 3, a UE positioned in the center of FIG. 3 has a PIN GC function. The UE may be called a PEGC.

The PECG may be connected to a PIN #1 and a PIN #2 (not illustrated), PINE 1 and PINE 2 connected to PIN #1 may access a DN via the PEGC and, similarly, PINE 3 may be connected to the DN via the PEGC.

The PEGC may use one PDU session or multiple PDU sessions to connect PIN #1 and PIN #2. FIG. 3 illustrates a network in which one session is used to connect PINE 1, PINE 2, PINE 3, . . . , and PINE n connected to each of PIN #1 and PIN #2.

PINE 1, PINE 2, PINE 3, . . . , and PINE n connected to PIN #1 and PIN #2 may be connected to different QoS flow in the PDU session via the PEGC.

As described above, a PECG maps a PINE to a QoS flow. Furthermore, the disclosure provides a method of mapping, by a PEGC, to a QoS flow, UL traffic from a PINE to a DN and forwarding same to a UPF, and a method of forwarding, by a PEGC to a PINE, DL traffic required to be transferred from a DN to the PINE.

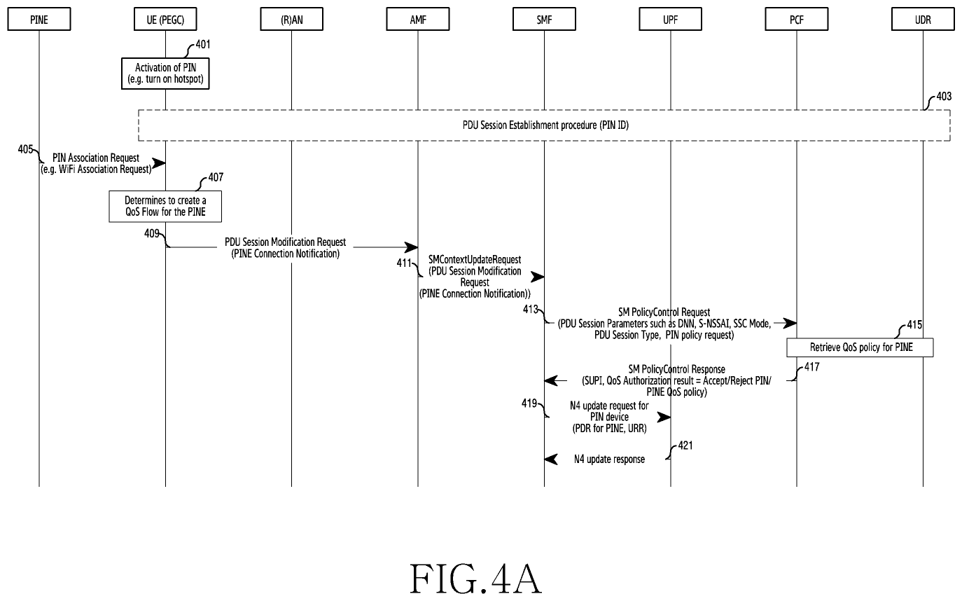

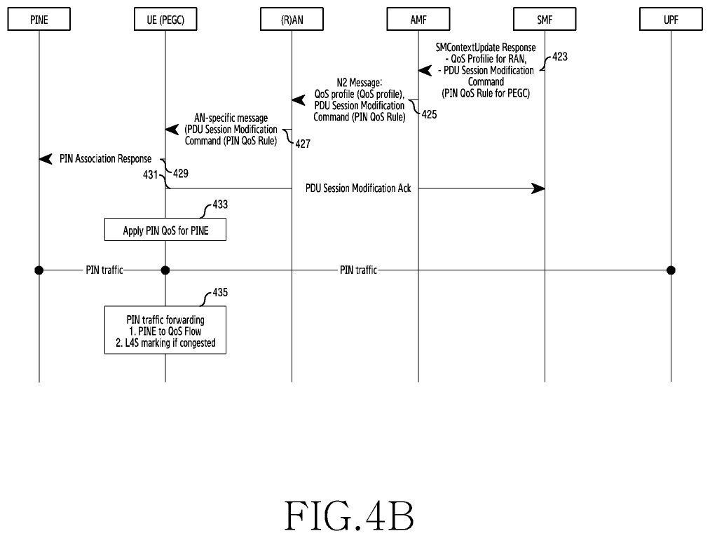

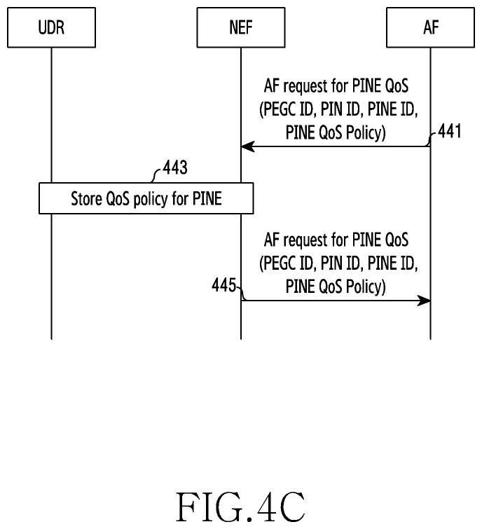

FIG. 4A is a signal flow diagram illustrating a method of generating a session for connection of a PIN device according to an embodiment. Specifically, FIG. 4A illustrates a procedure of generating a QoS flow according to connection of a PINE.

Referring to FIG. 4A, in step 401, a PEGC generates a PIN. The PEGC may activate a PIN from pre-configured information immediately after power is supplied, or may generate a PIN after receiving an input of activating the PIN from a user through a user experience (UX). A use example of activating the PIN through the UX may include using a hotspot provided in a mobile terminal.

In step 403, when the PIN is activated, the PEGC generates a PDU session corresponding to the PIN.

When the PEGC is configured to be in a shared PIN session mode of sharing one PDU session to transmit or receive traffic generated from an application of a terminal and traffic of a PIN, when the PIN is activated, a PDU session associated with the PIN may have already been generated.

When the PEGC is configured as a dedicated PIN session model using a PDU session exclusively for transmitting or receiving traffic of a PIN of a terminal, the PEGC may initiate a PDU session generation procedure by activating the PIN. Alternatively, when the PEGC is configured to be in the shared PIN session mode, and the PIN is activated, if a PDU session associated with the PIN has not been generated, the PEGC may generate a PDU session for PIN traffic transmission.

In step 405, a PINE is connected to the PEGC by a non-3GPP communication technology over the PIN, and the PINE requests a PIN connection from the PEGC through the non-3GPP communication technology.

When the PIN is connected by Wi-Fi, the PIN device may transmit, to the PEGC, an association request provided in a Wi-Fi communication protocol, to request generation of connection between the PIN device and the PEGC. When the PIN device and the PEGC are connected by a non-3GPP technology, the PEGC may obtain MAC address (or Ethernet address) information usable as traffic identification information of the PIN device.

In step 407, the PEGC receives the request of connecting to the PIN from the PINE having PIN connection through a non-3GPP communication technology, and determines to generate a PIN

QoS flow.

The PEGC may assign an IP address to the PIN device, and identify an IP address corresponding to an identifier for transmission of traffic of the PIN device, the identifier being obtained after the procedure of assigning the IP address. The IP address of the PIN device corresponds to a network address for communication between the PIN device and the PEGC in the PIN, and the IP address may be an address which is routable at the time of connection to a DN via the PEGC, or a private IP address used only in the PIN may be used. When a private IP address is used for the PIN device, the PEGC may use a NAT function, when communicating a DN, to use a converted IP address associated therewith.

In step 409, the PEGC determines to initiate QoS generation, and transfers a PDU session update request message (e.g., a PDU session modification message) to an SMF via an AMF. The PDU session update request message may include PIN device connection notification (PINE connection notification) information.

The PIN device connection notification information may include, but is not limited to:
An indicator requesting QoS association for each PIN device
PIN identifier: An identifier used to identify a PIN
PIN device identifier: An identifier of a PIN device managed by a PEMC
PIN session mode: A PIN session mode has various modes regulating correlation between a PIN network and a PDU session transmitting or receiving PIN traffic. For example, the PIN session mode may indicate a shared PIN session mode of using the same PDU session as a PDU session transmitting or receiving PIN traffic, as a PDU session for transmitting or receiving an application of a PEGC, or may indicate a dedicated PDU session mode exclusively for transmitting or receiving only PIN traffic.

PIN device traffic identifier: The identifier may include an IP address/port number, and an Ethernet address (MAC address). The PIN device traffic identifier may have the following information according to a PDU session type. If the PDU session type is IPv4, the IP address is a private IPv4 address allocated by a PEGC to a PIN device. When a PEGC uses NAT, a port number used for a PIN device may be included. If the PDU session type is IPv6, a PEGC performs IPv6 prefix delegation, and the IP address may be an IPv6 prefix or IPv6 address allocated by router advertisement. If the PDU session type is IPv4v6, the IP address may include both two types of an IPv4 address and an IPv6 prefix/address. If the PDU session type is Ethernet, the PIN device traffic identifier may be an Ethernet address or a MAC address.
Indicator of requesting generation of QoS flow for access of PIN device
QoS-related information requested by PEGC (UE)
   Low latency connection support request (L4S support request),
   QoS type such as guaranteed bit rate (GBR)/Non-GBR,
   UL/DL MFBR or GFBR requested by PEGC
   Estimated latency time in PIN connection interval

In step 411, the AMF transfers a request for updating SM context to the SMF. The SM context update request may include a PDU session update request message transmitted from the terminal. The PDU session update request message may include PIN device connection notification information.

In step 413, the SMF transfers an SM policy control request message to a PCF. The SM policy control request message may transfer a QoS policy request for the PIN. The QoS policy request for the PIN may be transferred after including a separate indicator indicating same (e.g., a PIN QoS request or a PIN device QoS request). The message may include the entire of PIN device connection notification information, received from the terminal, such as a PIN ID, a PINE ID, a PIN session mode, etc., or partial information extracted from PIN session notification information.

In step 415, the PCF identifies PIN-related information included in the SM policy control request message received from the SMF, and requests, from a UDR, PIN-related QoS policy information stored in the UDR with respect to the PIN-related information, to receive the PIN-related QoS policy information from the UDR. The information stored in the UDR may include PIN-related policy information and PINE-related QoS information. The information may include a PIN or PINE-related ECN/L4S-related policy. The PCF may determine a QoS-related policy for a request received from the SMF. The PCF may determine whether to allow a QoS policy for the PIN or the PIN device. For example, the PCF may determine a QoS policy for a QoS flow in which a PIN QoS policy for the PIN is mapped to the PIN at 1:1. For example, when an MBR for the PINE is configured as 10 mbps, the PCF may configure, as 10 mbps, an MFBR for a QoS flow associated with the PINE, to determine a QoS policy for the PINE.

In steps 415 and 417, the PCF may identify a PIN QoS-related policy, and transfers a PIN QoS policy or a PIN device-related QoS policy to the SMF. The PIN QoS policy or PIN device QoS policy may include a PIN identifier, a PIN device identifier, and PINE traffic identification information in addition to QoS information for a QoS flow and SDF distinguisher information enabling distinguishment of traffic represented by a policy and charging control (PCC) rule.

When a PIN device-related PCC rule is generated, the PCF may generate SDF distinguisher information through PIN device identifier information received from the SMF. For example, when PIN device information included in PIN device connection information is identification information, which is identifiable in a PDU session anchor (PSA)-UPF of a 5GC network, such as an Ethernet address, transport layer port information when NAT is used in IPv4, and an IPv6 prefix/address for IPv6, the PCF may generate a PCC rule by including, in an SDF of the PCC rule, PIN device identification information extracted from the PIN device connection information. The PINE traffic identification information may include information enabling identification of traffic transmitted or received to or from the PINE via the PIN connected to the PEGC. The PINE traffic identification information may be an IP address and an Ethernet address of the PINE. The PINE IP address may indicate an IPv4 address of the PINE in the PIN in a case of IPv4 and before the PEGC performs NAT for IPv4 when providing NAT.

If QoS information included in a PCC rule is information specific to a particular PIN device, the QoS information may include an indicator indicating a PIN device-dedicated flow. The PCF may determine a QoS flow for L4S processing, and transfer, to the SMF, a rule including an ECN/L4S-related rule or an indicator for supporting L4S by a separate QoS flow for a PIN device.

An L4S processing rule for a PIN device includes policy information for ECN or L4S marking at the time of congestion occurrence with respect to IP traffic transmitted or received to or from the PINE device by the PEGC. The policy information may include, but is not limited to:
An indicator indicating classic ECN support or L4S support.
Congestion occurrence level information: Congestion occurrence level information may show a congestion level threshold for marking an ECN congestion bit at the time of occurrence of, in the PEGC, congestion having a level higher than a designated congestion occurrence level.

In steps 419 and 421, the SMF updates a PINE-related traffic policy in the UPF. The SMF may generate a QoS-related rule (QoS enforcement rule (QER)) according to GFBR and MFBR information on the PIN device following a PCC rule received from the PCF, and configure the QoS-related rule for the UPF. The SMF may identify SDF information included in the PCC rule received from the PCF, generate a PDR rule therefrom, and configure the PDR rule for the UPF. The SMF may generate a QER to be configured for the UPF, from a QoS-related rule for the PINE. For example, when an MBR in the QoS of the PINE is configured, the SMF may configure, for the UPF, the MFBR as a value corresponding to a QER for the PEGC. When a separate PIN device-related traffic identifier or information enabling identification of the PIN device is received from the PCF, the SMF may configure PDR information, which is information for distinguishing PIN device traffic, by using the received identifier or information, and configure the PDR information for the UPF.

FIG. 4B is a signal flow diagram illustrating a method of generating a session for connection of a PIN device according to an embodiment. Specifically, FIG. 4B illustrates a procedure after steps 419 and 421 of FIG. 4A.

Referring to FIG. 4B, in step 423, the SMF determines whether to update a PDU session, by using information received from the PCF. The SMF transfers, to the AMF, QoS profile information, for a RAN, generated for the PIN device and a PDU session update command message to be transferred to the terminal.

The SMF may determine a QoS profile related to a QoS flow and to be applied in the RAN, from a PIN QoS-related rule received from the PCF. For example, when an MBR for the PINE is configured, the SMF may configure the MBR for the PINE as an MFBR for a QoS flow mapped to the PINE. The SMF may configure the configured MFBR value in a QoS profile, and transfer the QoS profile to a BS.

The SMF may generate a QoS rule to be transferred to the terminal, from a QoS-related rule for the PINE, and transfer the generated QoS rule to the terminal. For example, when a UL MBR in the QoS of the PINE is configured, the SMF may configure a UL MFBR in a QoS rule to be transferred to the terminal, and transfer the QoS rule to the terminal. The SMF may transfer, to the terminal, a PDU session update command message including such a PINE-related QoS rule.

The contents included in a PDU session update command may include a PIN QoS-related rule. The PIN QoS-related rule may be included in a QoS rule and then be transferred to the terminal. The PIN QoS-related rule may include PINE identification information, information enabling mapping of a QoS flow, and an L4S-related rule.

For example, the PIN QoS-related rule may include, but is not limited to:
QoS flow identifier
QoS flow information: MFBR and GFBR information
QoS flow-PIN device association information: PIN device identifier information, and PIN device traffic identification information (Ethernet address or IP address)
L4S-related rule: 1) L4S support indicator 2) Classic ECN or L4S performance information 3) Information for congestion marking (e.g., congestion level threshold information)

In step 425, the AMF transfers, to the BS, the QoS profile information and the PDU session update command message to be transferred to the terminal, which are received from the SMF. The BS may apply a QoS for a QoS flow, based on the received QoS profile information.

In step 427, the BS transfers the PDU session update command message received from the AMF, to the terminal (i.e., the PEGC). The PDU session update command message may include a QoS rule including a policy of applying an L4S processing function and information of mapping between a QoS flow and the PINE, which are intended by the SMF to transfer.

In step 429, the terminal having received a PDU session update command transmits a PIN association response to perform a PIN QoS-related rule for the PINE.

The PEGC may apply an MFBR and a GFBR for the PINE. The PEGC may search for a PDU session through PIN element to QoS flow mapping information with respect to traffic received from the PIN, search for a QoS flow in the PDU session, and transmit the traffic through the QoS flow.

In step 431, the terminal transmits an ACK message for update of the PDU session to the SMF.

In step 433, the terminal a PIN QoS-related rule applies a different PIN QoS policy to each PINE.

In step 435, the terminal forwards traffic transmitted or received by the PINE to or from the 5G network. Specifically, the terminal may perform, but is not limited to the following.
PINE to QoS flow traffic transfer function: When a device identified as a PINE is connected to the PIN, the terminal may map the PINE to a QoS flow, and transfer traffic received from the PINE to a 5GC through the QoS flow.
L4S processing function: The terminal may separately manage a packet received from a PIN device of the PIN and detect congestion occurrence. When congestion occurrence is detected, the terminal may perform L4S marking for corresponding traffic.

FIG. 4C is a signal flow diagram illustrating a method of generating a session for connection of a PIN device according to an embodiment. Specifically, FIG. 4C illustrates a process of obtaining a PIN device-related policy as in step 415 of FIG. 4A.

Referring to FIG. 4C, the PCF may obtain a PIN or PIN device-related policy from the UDR. A PIN or PIN device-related policy stored in the UDR may be a policy configured by a service provider in advance, or may be a policy stored from the AF via the NEF.

In step 441, the AF performs a procedure related to a PIN policy in the 5GC, via the NEF, when change and approval of a policy and a subscription condition in the 5GC are required in a process of registration in the PIN. For example, the AF may request the NEF to approve a policy relating to a QoS and registration of a new PIN device in the PIN.

In step 443, when approval of a policy relating to a QoS and registration of a new PIN device in the PIN is requested, the NEF stores a relevant policy in the UDR in a form of AF data.

In step 445, after storing a QoS policy related to the PINE in the UDR, the NEF requests the AF to approve the policy relating to the QoS and registration of the new PIN device in the PIN.

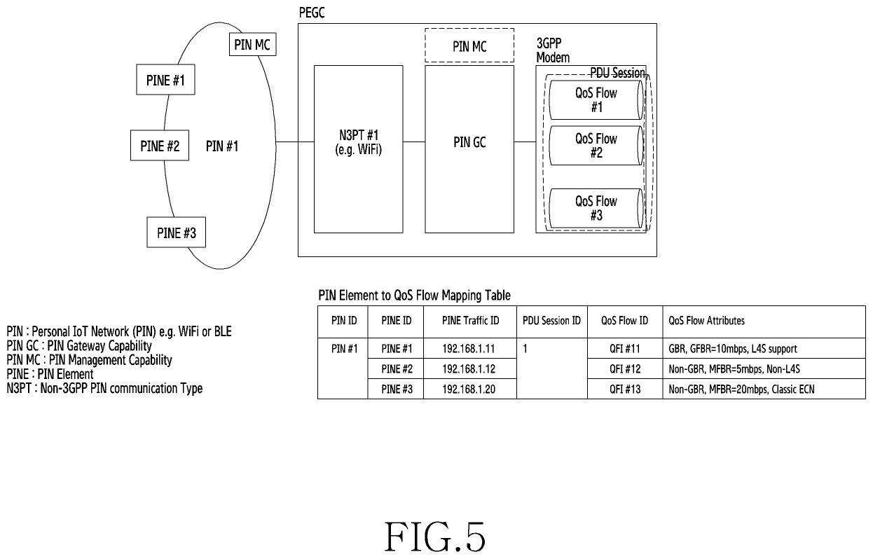

FIG. 5 illustrates a terminal mapping a QoS flow to each PIN device according to an embodiment. For example, FIG. 5 illustrates mapping PIN device traffic to a QoS flow provided in a 5G network as described in step 429 of FIG. 4B.

Referring to FIG. 5, a PEGC shows one PIN being provided in one PDU session. Although FIG. 5 illustrates one PIN and one PIN session, multiple PINs may exist and each PIN may be connected to a separate one PDU session.

The PEGC is connected to PIN #1 by a non-3GPP communication technology. Although FIG. 5 shows Wi-Fi as an example of the non-3GPP technology, the non-3GPP technology may include various wired/wireless access technologies, e.g., BLE or Ethernet, and may enable connection to a PIN. The PEGC has a PIN gateway function, and a PIN GC manages a PIN element to the QoS flow mapping table and provides a function of transmitting PIN traffic following the table to a 5G network via a 3GPP modem. In addition, the PIN GC provides a function of forwarding traffic received from the 5G network to a corresponding PIN device via the PEGC.

The PEGC may obtain information for identification of a PIN device via a PIN MC existing in the same terminal or a PIN MC existing in the PIN. The PIN GC may obtain information for associating PIN identification information with PIN traffic information, e.g., as in steps 403 to 405 in FIG. 4A. The PIN GC may obtain QoS information corresponding to a QoS flow related to identification information on a QoS flow mapped to a PIN device, through a PDU session update procedure.

Step 429 of FIG. 4B shows a procedure of transmitting or receiving PIN traffic in the PEGC, and in this process, the PEGC may search for a PDU session through PIN element to QoS flow mapping information with respect to traffic received from the PIN, search for a QoS flow in the PDU session, and transmit the traffic through the QoS flow.

In such a transmission process, the PIN GC may refer to QoS information corresponding to the QoS flow to distinguish and manage packets received from the PIN, and may perform an operation of performing additional QoS enforcement for input traffic according to QoS information of associated QoS flows, together with the packet processing of distinguishing and managing packets. For example, when the MFBR of a QoS flow is configured as 20 Mbps, the PEGC may shape a packet input from an N3PT such that the speed of the packet does not exceed 20 Mbps.

In addition, when a QoS flow is configured to support L4S or the PIN GC is explicitly configured to support L4S, and congestion is detected, the PIN GC may perform a function of marking CE of an ECN bit with respect to input IP traffic for which congestion is detected.

The PIN element to QoS mapping table of FIG. 5 includes a configuration in which one PIN is provided by one PDU session, three PIN devices in the PIN are connected to the PIN, and each PIN device is connected to a QoS flow. In the example, one PIN device is mapped to one QoS flow, but multiple PIN devices may be mapped to one QoS flow.

In the table, a PIN traffic identifier shows an example of being written by a IPv4 private IP address. PINE traffic identification information may be classified as an IPv6 prefix or IPv6 address, or an Ethernet address according to a PDU session type.

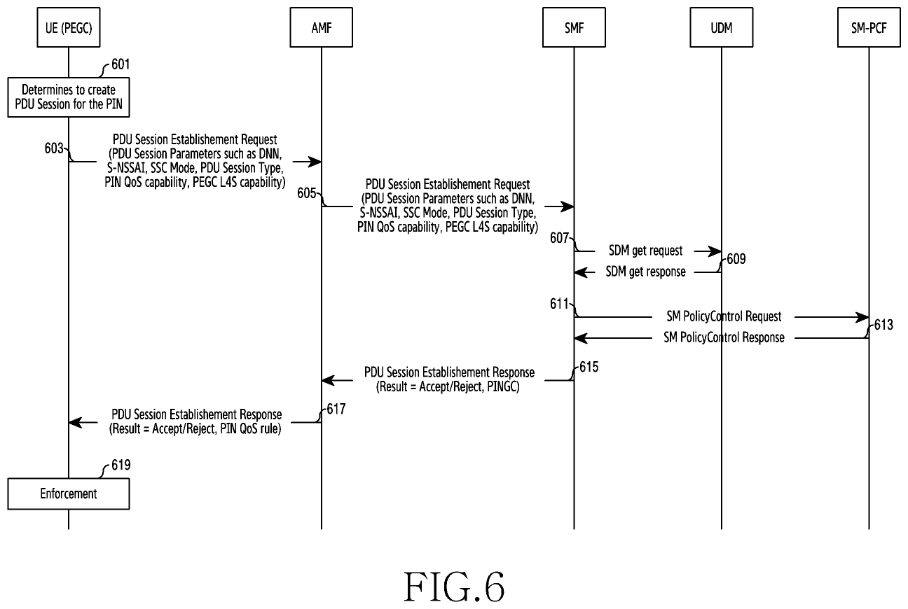

FIG. 6 is a signal flow diagram illustrating a method of generating a PIN QoS-supportable PDU session according to an embodiment. For example, FIG. 6 illustrates a PDU session generation procedure as in step 401 of FIG. 4A.

Referring to FIG. 6, in step 601, a PEGC initiates a PDU session generation procedure for a PIN.

In step 603, the terminal includes a PIN identifier, PIN session model information, and a PIN QoS-related PEGC capability in a PDU session generation request message, to initiate a PDU session generation request. The PDU session generation request is transferred to an SMF, via an AMF.

The PIN QoS-related PEGC capability may include:
PIN QoS capability: A function of the PEGC to enable connection of a QoS flow with one PIN device or multiple PIN devices distinguishable by PINE identifiers
PEGC L4S capability: An L4S processing function of the PEGC to receive a QoS-specific L4S/ECN processing rule for PEGC L4S/ECN support from the SMF, manage a separate queue for L4S traffic processing according to the received processing rule, and when a congestion situation occurs, perform ECN/L4S marking

In step 605, the AMF selects an SMF, includes a PDU session generation request in an SM context generation request for the SMF, and transfers same to the SMF. The PDU session generation request may include PIN QoS-related information transferred from the terminal.

In step 607, the SMF transfers an SM policy control request message to a PCF. The policy control generation request message may include PIN QoS-related PEGC capability information.

In step 609, the PCF having received a policy control generation request determines a PIN-related policy. The PIN-related policy may be a PIN session policy or a PIN QoS policy. The PIN-related policy may be divided and represented in a PIN session policy and a PIN QoS policy.

The PIN-related policy may include a PDU session model, a PIN QoS policy, and a PIN L4S policy.

In steps 611 and 613, the SMF performs an N4 update procedure.

In step 615, the SMF determines whether to generate a PDU session, by using information received from the PCF. The SMF transmits a PDU session generation request response message to the terminal via the AMF. The contents included in the PDU session generation response message may include a PIN session model required to be applied by the terminal, and PEGC function performance response information. A PIN QoS-related rule may be included in a QoS rule and then be transferred to the terminal.

The PEGC function performance response information may include:
Information indicating whether to permit performing a function of mapping a PIN device or multiple PIN devices to a QoS flow (QFI) of a 5GC
Information indicating whether to permit the PEGC to perform a L4S processing function for PIN traffic

In step 617, the AMF transfers, to the terminal, the PDU session generation request response message received from the SMF.

In step 619, the terminal having received a PDU session generation response performs the PEGC function performance response information.

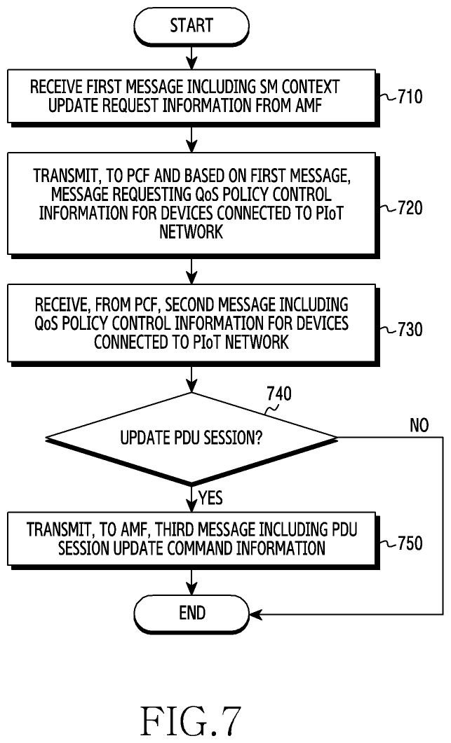

FIG. 7 is a flowchart illustrating a method of an SMF in a wireless communication system according to an embodiment.

Referring to FIG. 7, an SMF may provide an SMF, and when a UE has multiple sessions, the sessions may be managed by different SMFs. Specifically, the SMF may support a function, such as SM (e.g., this may mean an operation of session establishment, modification, and release, including tunnel maintenance between the nodes of a UPF and a (R)AN), UE IP address allocation and management (including selective authentication), selection and control of a UP function, configuration of traffic steering at the UPF to route traffic to a proper destination, termination of interfaces towards PCFs, execution of a control part of a policy and a QoS, lawful interception (e.g., this may relate to an SM event and an interface to an LI system), termination of SM parts of NAS messages, DL data notification, an initiator of AN-specific SM information (this is transferred to the (R)AN through N2 via the AMF), determination of an SSC mode of a session, and a roaming function. Some or all functions of the SMF may be supported in a single instance of one SMF.

In step 710, the SMF receives a first message including SM context update request information from an AMF. The SM context update request information may include PDU session update request information, and the PDU session update request information may include QoS-related information for devices, i.e., PINE, connected to a PIoT network, the information being transferred to the AMF from a terminal (i.e., a PEGC).

The SMF may request, from a PCF, QoS policy control information for the PINE, based on the received first message.

In step 720, the SMF receives, from the PCF, a second message including QoS policy control information for the devices connected to the PIN. The second message may be a response message, in response to a request made by the SMF from the PCF, for QoS policy control information for the PINE. The second message may include PIN QoS policy information or PINE QoS policy information on a policy that the PCF receives from the UDR and determines whether to allow. A PIN QoS policy or PIN device QoS policy may include a PIN identifier, a PIN device identifier, and PINE traffic identification information in addition to QoS information for a QoS flow and SDF distinguisher information enabling distinguishment of traffic represented by a PCC rule.

The SMF may transmit a message that requests a UPF to update a traffic policy for the PINE, based on the received second message.

In step 730, the SMF receives, from the UPF, a third message including update information of a traffic policy for the devices connected to the PIoT network.

The SMF may generate a QoS-related rule (e.g., a QER) according to GFBR and MFBR information on the PIN device following a PCC rule received from the PCF, and configure the QoS-related rule for the UPF. The SMF may identify SDF information included in the PCC rule received from the PCF, generate a PDR rule therefrom, and configure the PDR rule for the UPF. The SMF may generate a QER to be configured for the UPF, from a QoS-related rule for the PINE. For example, when an MBR in the QoS of the PINE is configured, the SMF may configure, for the UPF, the MFBR as a value corresponding to a QER for the PEGC. When a separate PIN device-related traffic identifier or information enabling identification of the PIN device is received from the PCF, the SMF may configure PDR information, which is information for distinguishing PIN device traffic, by using the received identifier or information, and configure the PDR information for the UPF.

In step 740, the SMF determines whether to update a PDU session, by using the information included in the second message received from the PCF.

In step 750, when update of the PDU session is determined, the SMF transmits, to the AMF, a fourth message including PDU session update command information. Specifically, the SMF may determine a QoS profile related to a QoS flow and to be applied in the RAN, from a PIN QoS-related rule received from the PCF. For example, when an MBR for the PINE is configured, the SMF may configure the MBR for the PINE as an MFBR for a QoS flow mapped to the PINE.

The SMF may configure the configured MFBR value in a QoS profile, and transfer the QoS profile to a BS.

The SMF may transfer, to the AMF, QoS profile information generated for the PIN device and a PDU session update command message to be transferred to the terminal. The AMF may transfer the corresponding message to the BS, and the BS may apply a QoS for a QoS flow, based on the received QoS profile information.

Thereafter, when the terminal updates a PDU session, the SMF may receive a PDU session modification ACK from the terminal.

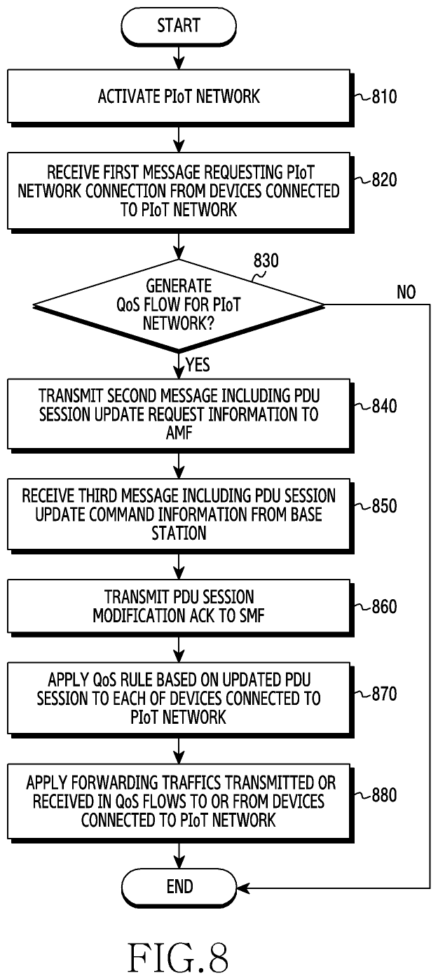

FIG. 8 is a flowchart illustrating a method of a terminal in a wireless communication system according to an embodiment.

Referring to FIG. 8, in step 810, the terminal (i.e., a PEGC) generates a PIN. That is, the terminal may activate a PIN. The terminal may activate a PIN from pre-configured information immediately after power is supplied, or may generate a PIN after receiving an input of activating the PIN from a user through a UX.

Thereafter, the terminal may perform a procedure of generating a PDU session corresponding to the activated PIN. When the PEGC is configured to be in a shared PIN session mode of sharing one PDU session to transmit or receive traffic generated from an application of a terminal and traffic of a PIN, and the PIN is activated, a PDU session associated with the PIN may have already been generated.

When the PEGC is configured as a dedicated PIN session model using a PDU session exclusively for transmitting or receiving traffic of a PIN of a terminal, the PEGC may initiate a PDU session generation procedure by activating the PIN. Alternatively, when the PEGC is configured to be in the shared PIN session mode, and the PIN is activated, if a PDU session associated with the PIN has not been generated, the PEGC may initiate a procedure of generating of a PDU session for PIN traffic transmission.

In step 820, the terminal receives a first message requesting PIN connection from devices connected to the PIN.

A PINE is connected to the PEGC by a non-3GPP communication technology over the PIN, and the PINE may request PIN connection from the terminal through the non-3GPP communication technology.

When the PIN is connected by Wi-Fi, a PIN device may transmit, to the terminal, an association request provided in a Wi-Fi communication protocol, to request generation of connection between the PIN device and the terminal. When the PIN device and the terminal are connected by a non-3GPP technology, the terminal may obtain MAC address (or Ethernet address) information usable as traffic identification information of the PIN device.

In step 830, the terminal determines whether to generate a QoS flow for the PIN, based on the first message. The terminal may determine whether to generate a QoS flow, based on whether the PIN is activated, and a time point of access of the devices connected to PIN.

In step 840, when generation of the QoS flow is determined, the terminal transmits a second message requesting update of a PDU session to the AMF. Specifically, the terminal may determine to initiate QoS generation, and transfer a PDU session update message to an SMF via an AMF. The PDU session update request message may include PIN device connection notification information.

The PIN device connection notification information may include:
Indicator of requesting QoS association for each PIN device
PIN identifier: An identifier used to identify a PIN
PIN device identifier: An identifier of a PIN device managed by a PEMC
PIN session mode: A PIN session mode has various modes regulating correlation between a PIN network and a PDU session transmitting or receiving PIN traffic. For example, the PIN session mode may indicate a shared PIN session mode of using the same PDU session as a PDU session transmitting or receiving PIN traffic, as a PDU session for transmitting or receiving an application of a PEGC, or may indicate a dedicated PDU session mode exclusively for transmitting or receiving only PIN traffic.
PIN device traffic identifier: The identifier may include an IP address/port number, and an Ethernet address (MAC address). The PIN device traffic identifier may have the following information according to a PDU session type. If the PDU session type is IPv4, the IP address is a private IPv4 address allocated by a PEGC to a PIN device. When a PEGC uses NAT, a port number used for a PIN device may be included. If the PDU session type is IPv6, a PEGC performs IPv6 prefix delegation, and the IP address may be an IPv6 prefix or IPv6 address allocated by router advertisement. If the PDU session type is IPv4v6, the IP address may include both two types of an IPv4 address and an IPv6 prefix/address. If the PDU session type is Ethernet, the PIN device traffic identifier may be an Ethernet address or a MAC address.
Indicator of requesting generation of QoS flow for access of PIN device
QoS-related information requested by PEGC (UE)
   Low latency connection support request (L4S support request),
   QoS type such as GBR/Non-GBR,
   UL/DL MFBR or GFBR requested by PEGC
   Estimated latency time in PIN connection interval

In step 850, the terminal receives a third message including PDU session update command information from a BS.

The third message including the PDU session update command information may include a QoS rule including a policy of applying an L4S processing function and information of mapping between a QoS flow and the PINE, which are intended by the SMF to transfer.

In step 860, the terminal updates the PDU session, based on the third message. In addition, the terminal having received a PDU session update command transmits a PIN association response to perform a PIN QoS-related rule for the PINE.

In step 870, the terminal applies a QoS rule to each of the devices connected to the PIN, based on the updated PDU session. The terminal performing a PIN QoS-related rule may apply a different PIN QoS policy to each PINE.

In step 880, the terminal forwards traffics transmitted or received in QoS flows to or from the devices connected to the PIN. Specifically, the terminal may perform the following operations:
PINE to QoS flow traffic transfer function: When a device identified as a PINE is connected to the PIN, the terminal may map the PINE to a QoS flow, and transfer traffic received from the PINE to a 5GC through the QoS flow.
L4S processing function: The terminal may separately manage a packet received from a PIN device of the PIN and detect congestion occurrence. When congestion occurrence is detected, the terminal may perform L4S marking for corresponding traffic.

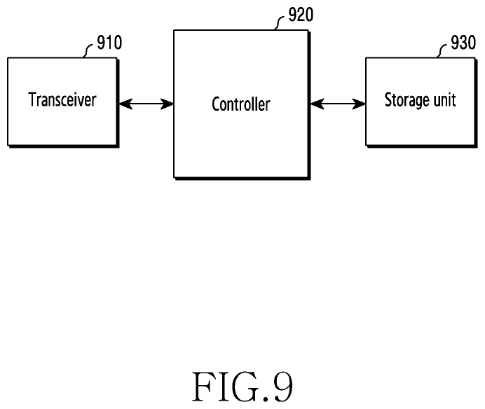

FIG. 9 illustrates a BS according to an embodiment.

Referring to FIG. 9, a BS includes a transceiver 910, a controller 920, and a storage unit 930. The transceiver 910, the controller 920, and the storage unit 930 may operate according to a communication method of a BS described above. A network device may also correspond to the structure of the BS. However, the elements of the BS are not limited to the above example. For example, the BS may also include more or fewer elements than the elements described above. In addition, the transceiver 910, the controller 920, and the storage unit 930 may be implemented in a single chip type.

The transceiver 910 may collectively indicate a receiver of the BS and a transmitter of the BS, and may transmit or receive a signal to or from a terminal, other BS, or other network devices. The transmitted or received signal may include control information and data. The transceiver 910 may, e.g., transmit system information to a terminal, or may transmit a synchronization signal or a reference signal. To this end, the transceiver 910 may include a radio frequency (RF) transmitter that up-converts and amplifies a frequency of a transmitted signal, an RF receiver that low-noise amplifies a received signal and down-converts the frequency, etc. However, the transceiver 910 described above merely corresponds to an embodiment, and the elements of the transceiver 910 are not limited to an RF transmitter and an RF receiver. The transceiver 910 may include a wired/wireless transceiver, and may include various elements for transmitting or receiving a signal. In addition, the transceiver 910 may receive a signal through a communication channel (e.g., wireless channel) and output the signal to the controller 920, and may transmit a signal output from the controller 920, through a communication channel. In addition, the transceiver 910 may receive a communication signal and output the same signal to a processor, and may transmit a signal output from the processor to a terminal, other BSs, or other entities through a wired/wireless network.

The storage unit 930 may store a program and data required for an operation of the BS. In addition, the storage unit 930 may store control information or data included in a signal obtained by the BS. The storage unit 930 may be configured by a storage medium such as read only memory (ROM), random access memory (RAM), a hard disk, a compact disc-ROM (CD-ROM), and a digital versatile disc (DVD), or a combination of storage mediums. In addition, the storage unit 930 may store at least one of information transmitted or received through the transceiver 910 and information generated through the controller 920.

The controller 920 may be defined as a circuit or an ASIC, or at least one processor. The processor may include a communication processor performing control for communication, and an application processor (AP) controlling a higher layer, such as an application program. The controller 920 may control the overall operation of the BS according to an embodiment proposed in the disclosure. For example, the controller 920 may control a signal flow between blocks to perform operations according to the flowcharts illustrated above.

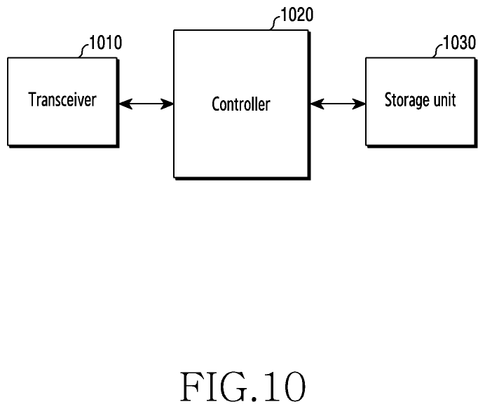

FIG. 10 illustrates a terminal according to an embodiment.

Referring to FIG. 10, a terminal includes a transceiver 1010, a controller 1020, and a storage unit 1030. The transceiver 1010, the controller 1020, and the storage unit 1030 may operate according to a communication method of a terminal described above. The elements of the terminal are not limited to the above example. For example, the terminal may also include more or fewer elements than the elements described above. In addition, the transceiver 1010, the controller 1020, and the storage unit 1030 may be implemented in a single chip type.

The transceiver 1010 collectively indicates a receiver of the terminal and a transmitter of the terminal, and may transmit or receive a signal to or from a BS, other terminals, or a network entity. The signal transmitted or received to or from a BS may include control information and data. The transceiver 1010 may, e.g., receive system information from a BS, or may receive a synchronization signal or a reference signal. To this end, the transceiver 1010 may include an RF transmitter that up-converts and amplifies a frequency of a transmitted signal, an RF receiver that low-noise amplifies a received signal and down-converts the frequency, etc. However, the transceiver 1010 described above merely corresponds to an embodiment, and the elements of the transceiver 1010 are not limited to an RF transmitter and an RF receiver. In addition, the transceiver 1010 may include a wired/wireless transceiver, and may include various elements for transmitting or receiving a signal. In addition, the transceiver 1010 may receive a signal through a wireless channel and output the signal to the controller 1020, and may transmit a signal output from the controller 1020, through a wireless channel. The transceiver 1010 may receive a communication signal and output the same signal to a processor, and may transmit a signal output from the processor to a network entity through a wired/wireless network.

The storage unit 1030 may store a program and data required for an operation of the terminal. In addition, the memory 1030 may store control information or data included in a signal obtained by the terminal. The storage unit 1030 may be configured by a storage medium such as ROM, RAM, a hard disk, a CD-ROM, and a DVD, or a combination of storage mediums.

The controller 1020 may be defined as a circuit or an ASIC, or at least one processor. The processor may include a communication processor performing control for communication, and an AP controlling a higher layer, such as an application program. The controller 1020 may control the overall operation of the terminal according to an embodiment proposed in the disclosure. For example, the controller 1020 may control a signal flow between blocks to perform operations according to the flowcharts illustrated above.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable ROM (EEPROM), a magnetic disc storage device, a CD-ROM, DVDs, or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof

What is claimed is:

1. A method performed by a user equipment (UE) in a wireless communication system, the method comprising:
receiving, from at least one electronic device, a first message requesting a connection to a personal Internet of things (PIoT) network (PIN);
identifying to generate a quality of service (QoS) flow for the at least one electronic device, based on the first message;
transmitting, to a session management function (SMF) entity, via an access and mobility management function (AMF) entity, a second message requesting a protocol data unit (PDU) session modification corresponding to the PIN;
receiving, from a base station (BS), a PDU session modification command message including a QoS rule; and
applying the QoS rule to the at least one electronic device.

2. The method of claim 1, further comprising forwarding, to a network entity of the PIN, traffic received from the at least one electronic device through the QoS flow.

3. The method of claim 1, wherein the second message includes connection notification information associated with the at least one electronic device for the PIN,
wherein the connection notification information includes at least one of a PIN identifier, identifier for the at least one electronic device connected to the PIN, an indicator requesting generate the QoS flow, or information related to the QoS flow, and
wherein the information related to the QoS flow includes information supporting a low latency, low loss, and scalable (L4S) function.

4. The method of claim 3, wherein the QoS rule includes at least one of information related to mapping the QoS flow or information associated with the L4S function.

5. A user equipment (UE) in a wireless communication system, the UE comprising:
a transceiver, and
a controller coupled with the transceiver and configured to:
receive, from at least one electronic device, a first message requesting a connection to a personal Internet of things (PIoT) network (PIN),
identify to generate a quality of service (QoS) flow for the at least one electronic device, based on the first message,
transmit, to a session management function (SMF) entity, via an access and mobility management function (AMF) entity, a second message requesting a protocol data unit (PDU) session modification corresponding to the PIN,
receive, from a base station (BS), a PDU session modification command message including a QoS rule, and
apply the QoS rule to the at least one electronic device for the PIN.

6. The UE of claim 5, wherein the controller further configured to forward, to a network entity of the PIN, traffic received from the at least one electronic device through the QoS flow.

7. The UE of claim 5, wherein the second message includes connection notification information associated with the at least one electronic device for the PIN,
wherein the connection notification information includes at least one of a PIN identifier, an identifier for the at least one electronic device connected to the PIN, an indicator requesting generate the QoS flow, or information related to the QoS flow, and
wherein the information related to the QoS flow includes information supporting a low latency, low loss, and scalable (L4S) function.

8. The UE of claim 7, wherein the QoS rule includes at least one of information related to mapping the QoS flow or information associated with the L4S function.

9. A method performed by a session management function (SMF) entity in a wireless communication system, the method comprising:
receiving, from a user equipment (UE), via an access and mobility management function (AMF) entity, a session management (SM) context update request message including a message requesting a protocol data unit (PDU) session modification corresponding to a personal Internet of things (PIoT) network (PIN);
transmitting, to a policy control function (PCF) entity, an SM policy control request message, based on the SM context update request message;
receiving, from the PCF entity, an SM policy control response message including information related to a quality of service (QoS) policy for at least one electronic device, in response to the SM policy control request message; and
transmitting, to a user plane function (UPF) entity, an update message requesting an update of traffic policy for an interface for the PIN.

10. The method of claim 9, further comprising:
receiving, from the UPF entity, an update response message including updated information of the traffic policy for the interface; and
transmitting, to the AMF entity, an SM context update response message including at least one of a QoS profile information or a protocol data unit (PDU) session modification command message corresponding to the PIN.

11. The method of claim 10, wherein the PDU session modification command message includes a QoS rule for at least one electronic device, and
wherein the QoS rule includes at least one of information related to mapping the QoS flow or information associated with a low latency, low loss, and scalable (L4S) function.

12. The method of claim 10, wherein the SM policy control request message includes information requesting a QoS policy for the PIN.

13. A session management function (SMF) entity in a wireless communication system, the SMF entity comprising:
a transceiver, and
a controller coupled with the transceiver and configured to:
receive, from a user equipment (UE), via an access and mobility management function (AMF) entity, a session management (SM) context update request message including a message requesting a protocol data unit (PDU) session modification corresponding to a personal Internet of things (PIoT) network (PIN),
transmit, to a policy control function (PCF) entity, an SM policy control request message, based on the SM context update request message,
receive, from the PCF entity, an SM policy control response message including information related to a quality of service (QoS) policy for at least one electronic device, in response to the SM policy control request message, and
transmit, to a user plane function (UPF) entity, an update message requesting an update of a traffic policy for an interface for the PIN.

14. The SMF entity of claim 13, wherein the controller further configured to:
receive, from the UPF entity, an update response message including updated information of the traffic policy for the interface, and
transmit, to the AMF entity, an SM context update response message including at least one of a QoS profile information or a protocol data unit (PDU) session modification command message corresponding to the PIN.

15. The SMF entity of claim 13, wherein the PDU session modification command message includes a QoS rule for at least one electronic device, and
wherein the QoS rule includes at least one of information related to mapping the QoS flow or information associated with a low latency, low loss, and scalable (L4S) function.

16. The SMF entity of claim 13, wherein the SM policy control request message includes information requesting a QoS policy for the PIN.
